(19) United States
(12) Patent Application Publication
(10) Pub. No.: US 2009/0202785 A1
(43) Pub. Date: Aug. 13, 2009

(54) REINFORCEMENT STRIP FOR A COMPOSITE PANEL

(75) Inventors: Jens Meyer Zu Drewer, Ratingen (DE); Jordanis Petrakis, Wuppertal (DE)

Correspondence Address: K.F. ROSS P.C., 5683 RIVERDALE AVENUE, SUITE 203 BOX 900, BRONX, NY, 10471-0900, US

(73) Assignee: W. DÖLLKEN & CO. GMBH, Gladbeck (DE)

(21) Appl. No.: 12/282,515

(22) PCT Filed: Mar. 12, 2007
(86) PCT No.: PCT/EP2007/002139

§ 371 Date: Mar. 5, 2009

(30) Foreign Application Priority Data
Mar. 11, 2006 (DE) 20 2006 003 857.4

(51) Int. Cl. B32B 7/00; B32B 5/00

(52) U.S. Cl. 428/192; 428/309.9

(57) ABSTRACT

The invention relates to a support strip for a composite panel, wherein the composite panel has at least two cover layers and at least one core layer arranged between the cover layers, wherein the support strip can be fastened to at least one of the narrow sides of the composite panel, and wherein a cover strip can be fastened on the support strip. The support strip is formed as an at least partially perforated support strip having at least one perforation consisting of a multitude of holes.

The invention relates to a reinforcement strip for a composite panel, the composite panel having at least two cover layers and at least one core layer between the cover layers, the reinforcement strip being fastened or fastenable to at least one of the narrow edges, or ends of the composite panel, a cover strip being fastened to the reinforcement strip. Such a reinforcement strip closes the narrow edge of a composite panel. Such a composite panel is also called a lightweight building panel, or a sandwich panel, and is used, for example, as a furniture panel or the like. The cover sheets or layers are preferably formed by relatively thin wood panels, such as particle board panels, MDF panels, or the like. However, the invention also comprises composite panels where one or both cover layers are made of plastic or a metal such as aluminum. The cover layers may also be made with multiple layers, or of several sheets. The core or center layer, for example, also consists of a honeycomb structure made, for example, of paper or cardboard, which is connected to the cover layers, for example, by means of adhesive. During production of, for example, furniture panels, it is common to fit the narrow edges with cover strips made of thermoplastic resin, these cover strips also being called edges, decor edges, or furniture edges. While a sufficient fastening surface is available during the fastening of such cover strips to solid wood panels, such as a particle board, on the narrow edges of the particle board, the fastening of cover strips on composite panels having a core layer proves difficult on a regular basis. For this reason reinforcement strips or edges, are initially fastened to the narrow edges, which then form a sufficient fastening surface for fastening the actual reinforcement strip.

In a known composite panel of the type described above, a groove is formed in at least one of the outer edges during production, so that a reinforcement strip, or profile strip, respectively, can be inserted into this groove, and another profile strip, such as a cover strip, is placed on top of this profile strip. The known reinforcement strips have a structured surface, by means of which the adhesion of the cover strip is improved on the reinforcement strip. The profile strips may also have a micro-porous foam structure that may be exposed during the course of milling (compare DE 20 2005 003 730). Mechanical processing only is required in order to ensure sufficient adhesion. As for the rest, suitability of the known reinforcement edges for radius processing is limited due to their high inherent stiffness.

The object of the invention is to create a reinforcement strip for a composite panel of the type described above, characterized by low production and installation costs, and enabling flawless fastening of the cover strip. Furthermore, a composite panel is to be provided having at least one such reinforcement strip.

In order to attain this object, the invention teaches that in a generic reinforcement strip for a composite panel of the type described above the reinforcement strip is formed as an at least partially perforated reinforcement strip having at least one perforation consisting of an array of holes.

The holes extend completely through the reinforcement edge such that a real perforation is provided with holes or bores completely traversing the reinforcement strip.

To this end the invention is based on the recognition that the perforations give improved adhesion to the reinforcement strip while adhering the cover strip using, for example a hot-melt adhesive. The adhesive penetrating into the holes leads to an extremely strong mechanical anchoring of the adhesive in the holes such that the adhesion quality of the cover strip, or of the decor strip, is significantly improved. To this end it is even possible for the hot-melt glue to penetrate the hole completely and reach behind the reinforcement edge such that the hardened hot-melt glue can then pass entirely through the reinforcement edge in the sense of an anchoring. Such a flawless bond is achieved, even if mechanical processing, such as milling, of the surface of the reinforcement edge is omitted after fastening the reinforcement edge and before fastening the cover strip. It is no longer necessary that the reinforcement strip have a structured surface for improving adhesion. However, the invention also comprises embodiments where the reinforcement strip is subjected to subsequent mechanical processing, such as milling, before fastening to a composite panel, and before fastening to the cover strip. Within the scope of the invention the reinforcement edge is preferably inserted into a reinforcement edge recess formed in the narrow edge of the lightweight panel. Such a reinforcement edge recess may be a groove. The depth of the groove substantially corresponds to the thickness of the reinforcement edge to be inserted such that the cover strip may subsequently be fastened to the narrow edge of the composite panel in a manner flush with the surface. From the production technical point of view, however, it may be advantageous to produce the reinforcement edge at a thickness that is slightly larger than the depth of the groove such that the part of the reinforcement strip protruding over the groove of the composite panel may be leveled, or ablated, flush with the front of the composite panel. However, it is of significant importance that this possible ablation within the scope of the invention serves only for creating a flush adhesion surface for the cover strip, and the creation of a structured surface is no longer necessary due to the already existing perforation. The use of reinforcement strips having a (micro-porous) foam structure is therefore no longer required. However, the invention also comprises reinforcement strips made of a foamed plastic material.

The invention further comprises reinforcement strips made of other materials, such as wood materials, paper, or cardboard. Within the scope of the invention, wood materials means, for example, MDF, wood extruders, or veneer. Within the scope of the invention, cardboard means particularly fiber board. The materials may also always be perforated reinforcement strips.

The holes of the perforation may have a (exterior) spacing to each other of 1 mm to 15 mm, such as 2 mm to 10 mm, preferably 4 mm to 6 mm. According to a further aspect of the invention the holes of the perforation are round, oval, rectangular, square, polygonal, or even star-shaped with the reinforcement edge being viewed from the top. Further, it may also be advantageous, if the, for example, round holes have a diameter of 0.1 mm to 5 mm, e.g. 0.1 mm to 1 mm, preferably 0.2 mm to 0.8 mm, particularly preferred of 0.3 mm to 0.5 mm. In holes other than round holes these specifications refer to the minimum and/or maximum diameter.

According to a further aspect the invention the holes have a cross-section expanding from the outside toward the inside of the reinforcement strip. In this regard, outside means the side of the reinforcement strip facing the cover strip, and inside means the side facing the composite panel, or the side of the reinforcement strip facing the core layer. To this end the invention is based on the knowledge that such a cross-section of the holes, expanding toward the rear, or toward the inside, ensures a particularly tight anchoring by the hardened hot-melt glue. Thus for example, a conical, or even a pyramidal hole passage can be formed. To this end a space may be provided in the hole passage center, or in the center of the hole. The hole geometries described also have an undercut bringing about the described advantages with the adhesion using the decor strips. The invention also comprises holes having a constant diameter along their entire lengths, such as cylindrical holes.

The invention further provides that the holes are arranged in a plurality of rows extending crosswise (Translator: parallel) to the reinforcement strip longitudinal direction. To this end it is possible that the rows have no offset to each other while forming a uniform grid pattern. The spacing of the rows and columns may be identical. However, it is also possible that two adjacent rows are arranged at an offset to each other lateral (Translator: parallel) to the reinforcement strip longitudinal direction. The offset of two rows to each other may be, for example, 2 mm to 6 mm, preferably 3 mm to 5 mm.

The reinforcement strips are preferably made of a plastic material, particularly of a thermoplastic resin. The same may be a polyolefin, such as polypropylene (PP), or polyethylene (PE), or even a polystyrene (such as ABS), and a polyvinyl chloride (PVC), or a polyester (such as PET). The materials for the production of the reinforcement strip may be unfilled, or filled with fillers. These fillers may be fillers on mineral basis (such as chalk, or talc), or on organic basis (such as wood fibers).

However, the invention not only comprises reinforcement strips made of plastic, but also of other materials, such as wood or cardboard.

In a preferred embodiment the reinforcement edge has a thickness of 1 mm to 30 mm, for example of 1 mm to 6 mm, preferably 1.5 mm to 5.5 mm. The width of the reinforcement edge is the same as the width of the composite panel, or the width of the reinforcement edge recess, such as the groove. Thus the width of the reinforcement edge is always slightly less than the width of the cover strip fastened to it.

The reinforcement strips may have a module of elasticity of 5 MPa to 15000 MPa. Preferably, reinforcement edges are utilized having an module of elasticity of 900 MPa to 3500 MPa, for example, 900 MPa to 2000 MPa. This module of elasticity refers to the initially unperforated strip in a pre-manufactured state.

Overall, the reinforcement strips according to the invention are characterized by a high flexibility, or bending elasticity such that they allow for outstanding radius processing, such as in furniture panels having rounded “edges.” This is achieved by the selection of the material stiffness, and the bending elasticity is further increased by the perforations. The reinforcement strips still provide a stable base for the subsequent fastening of the cover strips.

The inner face of the reinforcement edge facing the composite panel is equipped or coated with an adhesive, preferably in sections, in order to improve the bonding of the reinforcement strip in the area of the groove, or on the narrow edge of the composite panel. The fastening of the cover or decor strip on the reinforcement edge is preferably achieved by means of hot-melt glue. To this end the cover strip is also made of plastic. Generally known cover or decor edges may be used that are also called edge strips and that are fastened to narrow edges of common furniture panels made of, for example, particle board, or the like.

A substantial advantage of the perforated reinforcement strip is to be viewed in conjunction with the use of hot-melt glues in that they—similar to the narrow edges of a particle board—can be squeezed into the perforations, and thus into the narrow edge. For this reason a flawless or constant joint pattern is achieved such that the composite panels according to the invention are characterized by a flawless look.

Furthermore, not only is it possible to glue the reinforcement strip and/or the cover strip, but also to weld the reinforcement strip and/or the cover strip, for example, by way of laser beam welding, or ultrasonic welding.

Protection of the described perforated reinforcement strip independently as a composite panel closure is sought according to the scope of the invention. Thus particular significance is seen in this regard in the use of a perforated strip as a reinforcement strip for fastening a cover strip to a narrow edge of a composite panel. The reinforcement strips or edges may be produced as rolled goods and as a result are well suited for use in machines. The reinforcement edge according to the invention can be processed well both in curved or straight work with edge-strip gluing machines. The flexibility is further improved by means of the perforation without experiencing any loss of stability with regard to its reinforcing effect for the honeycomb panel.

The object of the invention is also a composite panel, having at least two cover layers and at least one core layer between the cover layers, a reinforcement strip of the type described above being fastened to at least one of the narrow edges of the composite panel and a cover strip being fastened, or being fastenable to this reinforcement strip. Preferably this reinforcement strip can be inserted into a reinforcement-strip recess of the composite panel, such as a groove, that is formed in the narrow edge of the composite panel. Thus protection is also sought within the scope of the invention for a composite panel having one or multiple reinforcement strips according to the invention.

The invention is described in further detail below based on a drawing illustrating only one embodiment. Therein:

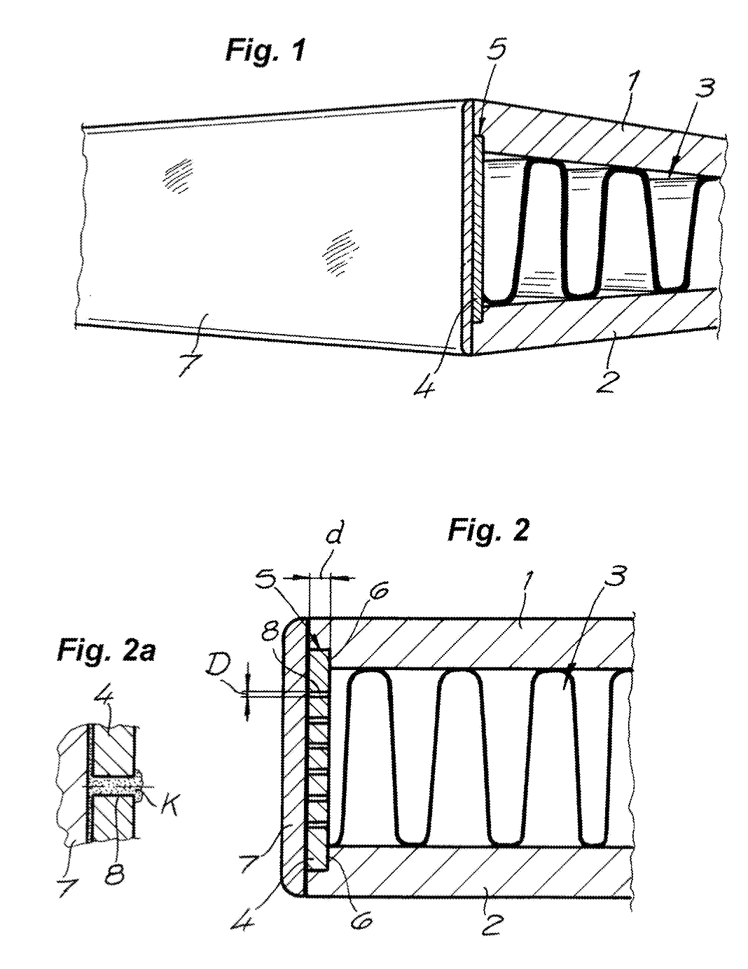

FIG. 1 is a perspective view of a composite panel having a reinforcement strip according to the invention,

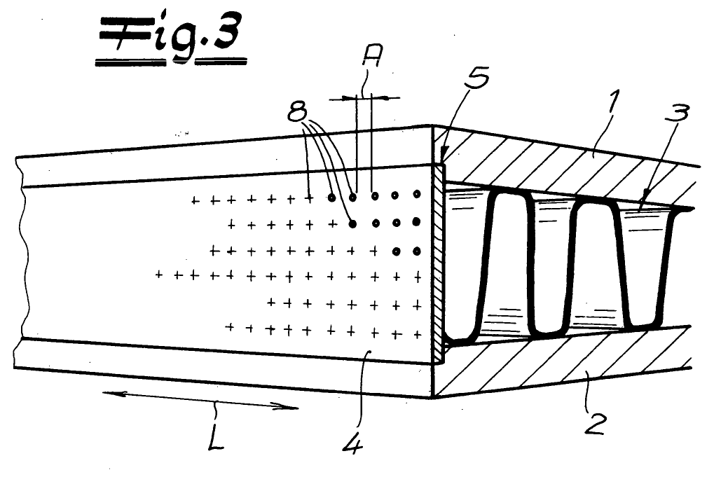

FIG. 2 is a cross-section across the object according to FIG. 1,

FIG. 3 shows the object according to FIG. 1 without a cover strip, and

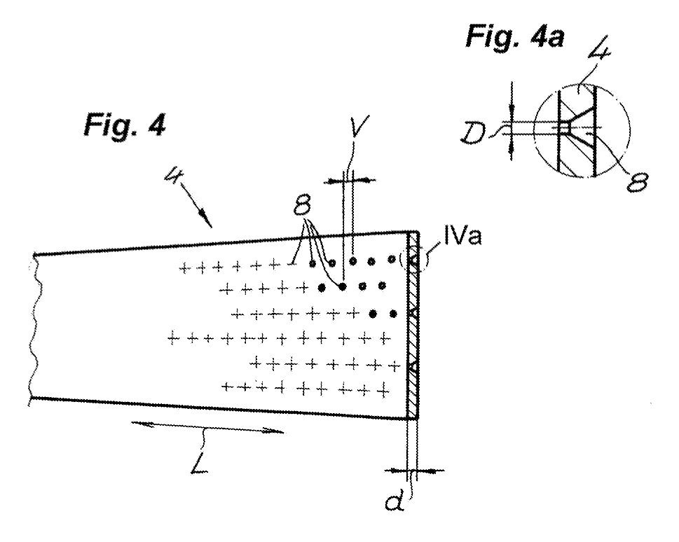

FIG. 4 shows a reinforcement strip in a modified embodiment.

FIGS. 1 and 2 illustrate a composite or sandwich panel having according to the invention two cover layers 1 and 2 and a core layer 3 arranged between the cover layers. The cover layers 1 and 2 are wood sheets, while the core layer 3 consists of a honeycomb structure, such as of cardboard. Such a composite or honeycomb panel is also called a lightweight panel and is used, for example, as a furniture panel. A reinforcement strip 4 made of plastic is fastened to one of the narrow edges, or ends of the composite panel. This reinforcement strip 4 is inserted into a groove 5 formed by two step-like grooves 6 in the cover layers 1 and 2. A cover strip 7, which is also called a decor edge, is then fastened to the reinforcement strip 4. This may be a known decor edge made of plastic.

According to the invention the reinforcement strip 4 is formed as a reinforcement strip that is perforated over its entire length (or only in sections), having a perforation consisting of a multitude of holes 8. This is obvious particularly in FIG. 3, wherein the cover strip is illustrated. It is obvious that the surface of the perforated reinforcement strip 4 (possibly after milling) is flush with the outer edges of both cover layers 1 and 2 such that subsequently a generally known cover strip 6 can be fastened to the edge of the composite panel. The fastening of the cover strip 7 on the reinforcement strip 4 is done using hot-melt glue K that can penetrate the holes 8 according to the invention to create a rivet-like anchoring, since part of the hot-melt glue K can penetrate the holes 8 completely and can engage the inner face of the reinforcement edge 4 (compare to the enlarged section in FIG. 2). Subsequently, a strong mechanical anchoring of the hot-melt glue K in the holes 8 is achieved such that the quality of the bond of the cover strip 7, or the decor edge is significantly improved.

In the illustrated embodiment the holes 8 are arranged in multiple rows that are perpendicular (Translator: parallel) to the reinforcement edge longitudinal direction L. FIG. 3 illustrates an embodiment where the rows are not offset and form a uniform grid pattern. On the other hand, FIG. 4 illustrates a modified embodiment, wherein two adjacent rows are arranged at an offset to each other lateral (Translator: parallel) to the reinforcement edge longitudinal direction L. The offset V in the illustrated embodiment is approximately 3 mm to 5 mm.

The holes have a (edge-to-edge) spacing A between adjacent holes 8 of 1 mm to 15 mm, for example, 2 mm to 10 mm, preferably 4 mm to 6 mm. In the illustrated embodiment 5 mm is provided. The holes 8 are round when viewed from the top, a diameter D of 0.1 mm to 5 mm, for example 0.1 mm to 1 mm, preferably 0.2 mm to 0.8 mm being advantageous. In the illustrated embodiment the diameter D is approximately 0.3 mm to 0.5 mm.

FIG. 4 illustrates a preferred embodiment according to the invention where the holes 8 have a cross-section, or diameter expanding from the outer side to the inner side of the reinforcement strip. Thus both conical or frustoconical holes 8 are formed (e.g. holes formed conical or frustoconical along part of their length) such that the holes 8 are undercut, further improving the anchoring by the hot-melt glue. In such embodiments having an undercut the described anchoring is achieved when the hot-melt glue reaches the undercut such that the hot-melt glue does not need to completely penetrate through the hole.

On the other hand, FIGS. 2 and 3 show a modified embodiment where the diameter D of the holes 8 is constant across the entire length, or strip thickness such that the holes 8 have a cylindrical shape.

In the embodiments having a flaring cross-section, the references to the diameter of the holes 8 refer to the minimum diameter, which is preferably provided in the area of the outer face of the reinforcement strip 4.

The reinforcement strip 4 itself has a thickness d of 1 mm to 6 mm, for example 1.5 mm to 5.5 mm. In order to improve the bond between the reinforcement strip 4 and the composite panel or the cover layers 1 and 2, the bottom of the reinforcement strip facing the composite panel is coated with an adhesive.

1. A reinforcement strip for a composite panel having at least two cover layers and at least one core layer between the cover layers,
the reinforcement strip being fastenable to at least one of the narrow edges of the composite panel and
a cover strip being fastenable to the reinforcement strip wherein
the reinforcement strip is formed at least partially as a perforated reinforcement strip having at least one perforation consisting of a multitude of holes.

2. The reinforcement strip according to claim 1 wherein the reinforcement strip is fittable to a reinforcement strip recess, such as a groove, that is formed in the narrow edge of the composite panel.

3. The reinforcement strip according to claim 1 wherein the holes of the perforation have a spacing of 1 mm to 15 mm, for example 2 mm to 10 mm, preferably 4 mm to 6 mm.

4. The reinforcement strip according to claim 1 herein the holes of the perforation are made round, oval, rectangular, square, polygonal, or star-shaped, when viewing the reinforcement strip from the outside.

5. The reinforcement strip according to claim 1 wherein the holes have a diameter of 0.1 mm to 5 mm, for example 0.1 mm to 1 mm, preferably 0.2 mm to 0.8 mm, particularly preferred of 0.3 mm to 0.5 mm.

6. The reinforcement strip according to claim 1 wherein the holes have a flaring cross-section or diameter, and/or are formed with an undercut.

7. The reinforcement strip according to claim 1, wherein the holes are arranged in multiple rows arranged transversely to the reinforcement strip longitudinal direction.

8. The reinforcement strip according to claim 7, wherein the rows are not staggered relative to each other.

9. The reinforcement strip according to claim 7, wherein two adjacent rows are arranged at an offset to each other lateral to the reinforcement strip longitudinal direction, the offset being 2 mm to 6 mm.

10. The reinforcement strip according to claim 1 wherein the reinforcement strip is made of a polyolefin, a polystyrene, a polyester, or a polyvinyl chloride.

11. The reinforcement strip according to claim 1 wherein the reinforcement strip has a thickness of 1 mm to 30 mm.

12. The reinforcement strip according to claim 1 wherein the reinforcement strip has an module of elasticity of 5 MPa to 15000 MPa.

13. The reinforcement strip according to claim 1 wherein the inside face of the reinforcement strip facing the composite panel is equipped with an adhesive, at least in sections.

14. The reinforcement strip according to claim 1 wherein the cover strip is fastened to the reinforcement strip by means of a hot-melt glue.

15. A composite panel, having at least two cover layers and at least one core layer arranged between the cover layers, wherein at least one reinforcement strip according to claim 1 is fastened to at least one of the narrow edges of the composite panel, a cover strip being fastened, or being fastenable to the reinforcement strip.

16. The composite panel according to claim 15 wherein the reinforcement strip is inserted into a reinforcement strip recess, such as a groove formed in the narrow edge of the composite panel.

17. A composite panel comprising:
a pair of parallel outer sheets having parallel spaced edges each formed with an outwardly open groove;
a core layer between and fixed to the outer sheets;
a reinforcement strip fixed in the grooves, having an outer face and an inner face, and formed with an array of throughgoing holes;
a decor strip overlying the outer face of the reinforcement strip and the edges of the outer sheets outward of the reinforcement strip; and
an adhesive bonding an inner face of the decor strip to the reinforcement strip and extending substantially through the holes of the reinforcement strip.

18. The composite panel defined in claim 17 wherein the reinforcement strip is substantially flush with the edges of the outer sheets outward of the grooves.

19. The composite panel defined in claim 17 wherein the holes are of greater cross sectional size at the inner face of the reinforcement strip than at the outer face of the reinforcement strip.

20. The composite panel defined in claim 17 wherein the decor strip is wider than the reinforcement strip and has longitudinal outer edges flush with outer faces of the outer sheets.
